(19) United States
(12) Patent Application Publication
(10) Pub. No.: US 2026/0301564 A1
(43) Pub. Date: Oct. 1, 2026

(54) SYSTEM AND METHOD ENABLING CONNECTED AND AUTONOMOUS VEHICLES (CAVS) USING WIRELESS COMMUNICATION

(71) Applicants: Aniket Vijay GORE, Pune (IN); Ashish Ulhas MOKALKAR, Akola (IN); Yi Xien Yap, Kuala Lumpur (MY)

(72) Inventors: Aniket Vijay GORE, Pune (IN); Ashish Ulhas MOKALKAR, Akola (IN); Yi Xien Yap, Kuala Lumpur (MY)

(21) Appl. No.: 19/101,015

(22) PCT Filed: Aug. 4, 2023
(86) PCT No.: PCT/IB2023/057906

§ 371 Date: Feb. 4, 2025

(30) Foreign Application Priority Data
Aug. 4, 2023 (IN) 202221044543

(51) Int. Cl. G08G 1/01; G01S 17/32; G01S 17/58; G01S 17/86; G01S 17/931; G08G 1/052

(52) U.S. Cl. CPC G08G 1/0141; G01S 17/32; G01S 17/58; G01S 17/86; G01S 17/931; G08G 1/0112; G08G 1/0133; G08G 1/052

(57) ABSTRACT

The present disclosure relates to a system (100) that includes a device (102) having a set of sensors (104) to capture the first set of attributes. The device includes a set of network elements to capture a second set of attributes. A processor (116) configured to extract the first set of attributes pertaining to velocity, speed, direction, distance, and position on road of the objects. The processor is configured to extract the second set of attributes pertaining to location data and proximity data of the objects. The processor (116) is configured to fuse the first set of attributes and the second set of attributes to form an occupancy grid map of objects in real time to create a local dynamic map (LDM) of the observed area.

### TECHNICAL FIELD

The present disclosure relates, in general, to an autonomous vehicle, and more specifically, relates to a system and method enabling connected and autonomous vehicles (CAVs) to run software applications using wireless communication technologies such as Cellular-vehicle to everything (V2X) and fifth generation wireless communications (5G) technologies.

### BACKGROUND

The CAVs have stringent requirements specified by the society of automotive engineers, (SAE) for different levels of automated driving, especially for level 4/level 5. These lead to multiple expensive sensors installed on CAVs, which contributes to an increase in processing power required on CAV e.g., ego vehicles. The present system can include devices on roadside infrastructure for 3D mapping of all types of objects in its field of view, including but not limited to on road vehicles, humans, and animals on sidewalks, in real-time using LiDAR sensors. This creates of 3D local dynamic map of the sensor-observed area, this and related data is sent to an edge cloud using a private 5G network which is designed to meet all connectivity requirements of Standard Development Organisations such as SAE, 3rd Generation Partnership Project (3GPP), and European Telecommunications Standards Institute (ETSI) standards. CAV applications can process this data collected from roadside hardware in conjunction with sensors installed on ego vehicles to detect, segment, classify, and track objects using Artificial Intelligence (AI) at an edge cloud. This increases object detection and tracking range of individual ego vehicles, making CAVs more aware of their surroundings in real-time, resulting in increased driving safety while simultaneously reducing the number of sensors and processing power required per ego vehicle. The present disclosure can be described in enabling detail in the following examples, which may represent more than one embodiment of the present disclosure.

Current technologies in the field of invention are divided into separate parts such as LiDAR sensor, 5G cellular connectivity and Cellular-vehicle-to-everything (V2X) wireless communications services. These technologies are different and have separate applications. LiDAR systems use wave light properties to calculate distances instead of modulating the intensity of the transmitted signal, whereas 5G works on the principles of radio frequency (electromagnetic fields). V2X is a type of vehicular communications technology enabling information exchange between a vehicle and supporting surrounding infrastructure. LiDAR sensors use eye-safe laser beams to create a high-resolution 3D point cloud representation of the surveyed environment in real time, whereas radio waves are used to transmit and receive information using transceivers over an air interface in 5G technologies.

LiDAR is limited by occlusion as objects occluded by other objects are not detected by LiDAR sensor and by use of lasers with emission wavelengths often called eye safe. However, LiDAR is affected by occlusion; the accuracy and reliability of object detection can be reduced when occlusion occurs. The wireless communications are limited by time, spectrum, and power resources at the transceiver, these are managed by radio resource management (RRM) and shared by multiple users called multiple access (MA).

Therefore, it is desired to overcome the drawbacks, shortcomings, and limitations associated with existing solutions, and develop a system that makes CAVs aware of their surroundings.

### OBJECTS OF THE PRESENT DISCLOSURE

An object of the present disclosure relates, in general, to any connected vehicle or thing, and more specifically, relates to a system and method enabling connected and autonomous vehicles (CAVs) to run software applications using C-V2X and private 5G.

Another object of the present disclosure is to provide a system that makes CAVs more aware of their surroundings.

Another object of the present disclosure is to provide a system that simultaneously reduces the number of sensors and processing power required per ego vehicle.

Another object of the present disclosure is to provide a system that enables vehicles to securely share all the data among neighbouring objects such as infrastructure, pedestrians, vehicles etc. using private 5G and V2X technologies to achieve collective perception.

Yet another object of the present disclosure is to provide a system that accurately localises a CAV in the real world and identifies distance between other objects in the surrounding environment based on their proximity to the roadside unit and exchanges information with other objects in its environment in order to create a shared view of the real world

### SUMMARY

The present disclosure relates in general, to an autonomous vehicle, and more specifically, relates to a system and method enabling connected and autonomous vehicles (CAVs) to run applications using wireless communication technologies such as Cellular-vehicle to everything (V2X) and private fifth generation wireless communications (5G).

The system for connected and autonomous vehicles (CAV), the system comprising an infrastructure mounted device e.g., roadside unit (RSU) equipped with a set of sensors to capture a first set of attributes in the form of depth and velocity including doppler effect information. An RRU gNB and V2X RSU transceivers configured in the device to capture a second set of attributes; and a processor operatively coupled to device, the processor configured to extract, from the set of sensors, the first set of attributes, the first set of attributes pertain to velocity including doppler effect, speed, direction, distance, and position including proximity of the on-road objects with respect to the RSU. The processor can receive from an RRU gNB and V2X RSU antenna, the second set of attributes, the second set of attributes pertains to location data and proximity data of the objects. The processor can fuse the first set of attributes and the second set of attributes to form an occupancy grid map of objects in real time to create a local dynamic map of the observed area and transmit the occupancy grid map data of the objects in real time to any interested parties over a communication network.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The following drawings form part of the present specification and are included to further illustrate aspects of the present disclosure. The disclosure may be better understood by reference to the drawings in combination with the detailed description of the specific embodiments presented herein.

FIG. 1A illustrates an exemplary edge site connected using a network slice, in accordance with an embodiment of the present disclosure.

FIG. 1B illustrates an exemplary hardware component, in accordance with an embodiment of the present disclosure.

FIG. 1C illustrates an exemplary hypothetical installation of a hardware component on a traffic signal column at an intersection, in accordance with an embodiment of the present disclosure.

FIG. 1D illustrates a cellular vehicle to everything (C-V2X) application, in accordance with an embodiment of the present disclosure.

FIG. 1E illustrates an example from ETSI GS MEC 002, in accordance with an embodiment of the present disclosure.

FIG. 1F illustrates an example use case from ETSI GS MEC 002, in accordance with an embodiment of the present disclosure.

FIG. 1G illustrates object data extraction levels to be considered as a part of CP basic service, in accordance with an embodiment of the present disclosure.

FIG. 1H illustrates an implementation in which the CP basic service selects objects to be transmitted as part of the CPM from a high-level fused object 15 list, in accordance with an embodiment of the present disclosure.

FIG. 1I illustrates a schematic view of the road side unit, in accordance with an embodiment of the present disclosure.

FIG. 1J illustrates a schematic view of local dynamic map, in accordance with an embodiment of the present disclosure.

FIG. 1K illustrates a structure of the LDM, in accordance with an embodiment of the present disclosure.

FIG. 2A illustrates an exemplary roadside hardware component sensing its surrounding road environment, in accordance with an embodiment of the present disclosure.

FIG. 2B illustrates exemplary roadside hardware sensing a reference position of a vulnerable road user (VRU), in accordance with an embodiment of the present disclosure.

FIG. 2C illustrates exemplary roadside hardware (R-ITS-S) creates a proximity-based grid occupancy map of its surrounding road environment, in accordance with an embodiment of the present disclosure.

FIG. 2D illustrates an exemplary framework of the roadside hardware component, in accordance with an embodiment of the present disclosure.

FIG. 3A illustrates an exemplary implementation of roadside V2X service, in accordance with an embodiment of the present disclosure.

FIG. 3B illustrates an exemplary logical implementation of the roadside unit in 5GS, in accordance with an embodiment of the present disclosure.

FIG. 3C illustrates an exemplary high-level view of the non-roaming 5G system architecture for V2X communication, in accordance with an embodiment of the present disclosure.

FIG. 4 illustrates a flow chart of a method for determining the surrounding environment for CAVs, in accordance with an embodiment of the present disclosure.

### DETAILED DESCRIPTION

The following is a detailed description of embodiments of the 10-disclosure depicted in the accompanying drawings. The embodiments are in such detail as to clearly communicate the disclosure. If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The present disclosure relates, in general, to an autonomous vehicle, and more specifically, relates to a system and method enabling connected and autonomous vehicles (CAVs) to run applications using V2X and private 5G. The proposed system disclosed in the present disclosure overcomes the drawbacks, shortcomings, and limitations associated with the conventional system by providing a system for determining the surrounding environment for CAVs. The system includes a device having a set of sensors to capture the first set of attributes in the form of depth and velocity information. The device includes a wireless base station (eNB/gNB) remote radio unit (RRU) and V2X roadside units (RSU) transceivers to capture a second set of attributes. A processor is operatively coupled to a learning engine to extract the first set of attributes in the form of depth information from the set of sensors, the first set of attributes pertaining to velocity, speed, direction, distance, and position on road of the objects. The processor is configured to receive the second set of attributes pertaining to location data and its proximity data of the objects from the base station (gNB) RRU and V2X RSU antenna. The processor is configured to fuse the first set of attributes and the second set of attributes to form an occupancy grid map of on-road objects in real-time to create a local dynamic map of the observed area and send it to any interested parties including but not limited to any vehicles, pedestrians, animals on the road.

The present disclosure provides a system for connected and autonomous vehicles (CAV), the system includes a device (102) equipped with a set of sensors (104) to capture a first set of attributes, a set of network elements configured in the device to capture a second set of attributes and a processor (116) operatively coupled to the device; the processor configured to extract, from the set of sensors, the first set of attributes, the first set of attributes pertain to velocity, speed, direction, distance, and position of the objects. The processor extract, from the set of network elements, the second set of attributes, the second set of attributes pertains to location data and proximity data of the objects. Fuse the first set of attributes and the second set of attributes to form an occupancy grid map of objects in real time to create a local dynamic map (LDM) of the observed area; and share the occupancy grid map data of the objects in real time to any interested parties over a communication network.

In an aspect, the device is spatially distributed at strategic locations such as on streets, highways, intersections, blind spots, high accident risk areas and any combination thereof, wherein the device enable services contributing towards road safety and traffic efficiency information and to control the movement of various objects in a safe and efficient manner.

In an aspect, the set of sensor elements (104) is Frequency Modulated Continuous Wave (FMCW) LiDAR and the set of network elements is i.e., remote radio unit (RRU) (gNB) wireless base station (106) and vehicle-to-everything (V2X) roadside units (RSU) (108). The device (102) comprises reconfigurable radio systems (112) that exploit the capabilities of reconfigurable radio and networks for self-adaptation to a dynamically-changing environment having learning capabilities, wherein the reconfigurable radio acquires knowledge of the radio operational environment and autonomously adjust its operational parameters and protocols accordingly, thereby facilitating the collection of cognitive radio context information for informed decision making.

Moreover, the processor (116) is operatively coupled to a learning engine to extract the first set of attributes and the second set of attributes to form the occupancy grid map by object fusion mechanism, wherein the learning engine is deep learning engine. The object fusion mechanism enables predictive tracking, association, and merging of object data from various set of sensors and V2X information, providing an updated object list for informed decision-making in Intelligent Transportation Systems (ITS), wherein the object fusion mechanism performs housekeeping tasks, including adding, updating, and removing state spaces for tracked objects based on sensor data, and supports object classification capabilities based on the fusion capabilities. Further, the Local Dynamic Map (LDM) employs a distributed ledger architecture, facilitating secure access to its data through permission-based processes and modular possibilities. The LDM stores information in the form of LDM data objects, which can be composed of sub-objects, resembling the hierarchical structure of data frames in messages. These LDM Data Objects are equipped with attributes that represent various data elements, wherein the data is received from a range of different sources such as internet, connected vehicles, infrastructure units, traffic control unit, personal ITS stations, and onboard sensors and applications.

The local dynamic map determine whether a point P(x, y) is located inside, outside, at the center, or at the border of a geographical area, which comprise circular area, rectangular area, ellipsoidal area and any combination thereof. Further, the device (102) is configured as an extended sensors system that facilitates the exchange of raw or processed data obtained from local sensors or live video data among vehicles, roadside units, user equipment (UEs) of pedestrians, and Vehicle-to-Everything (V2X) application servers, wherein through this exchange, vehicles gain the capability to enhance their environmental perception beyond the limitations of their own sensors, thereby achieving a more comprehensive and holistic view of the local situation.

The advantages achieved by the system of the present disclosure can be clear from the embodiments provided herein. The system makes CAVs more aware of their surroundings, resulting in the driving safety of the user. The system simultaneously reduces the number of sensors and processing power required per ego vehicle and enables vehicles to securely share all the data among neighbouring vehicles using permissioned distributed ledger based 5G and V2X technologies to achieve collective perception of the real world.

Further, the system localises a CAV in the real world and identifies the distance to other objects in the surrounding environment based on their proximity to RSU and exchanges information with other objects in its environment. The description of terms and features related to the present disclosure shall be clear from the embodiments that are illustrated and described; however, the invention is not limited to these embodiments only. Numerous modifications, changes, variations, substitutions, and equivalents of the embodiments are possible within the scope of the present disclosure. Additionally, the invention can include other embodiments that are within the scope of the claims but are not described in detail with respect 10 to the following description.

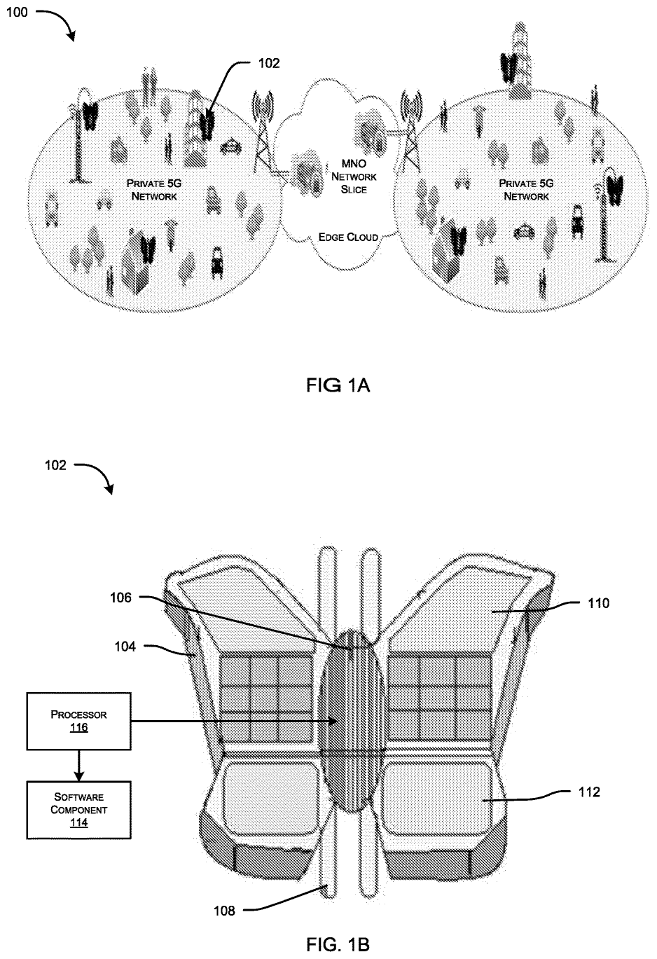

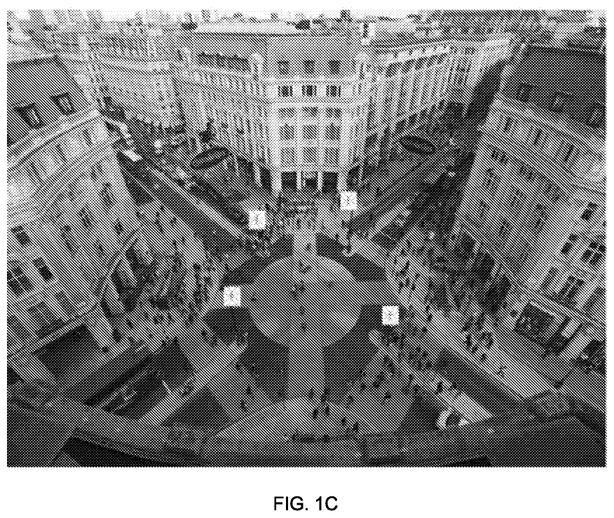

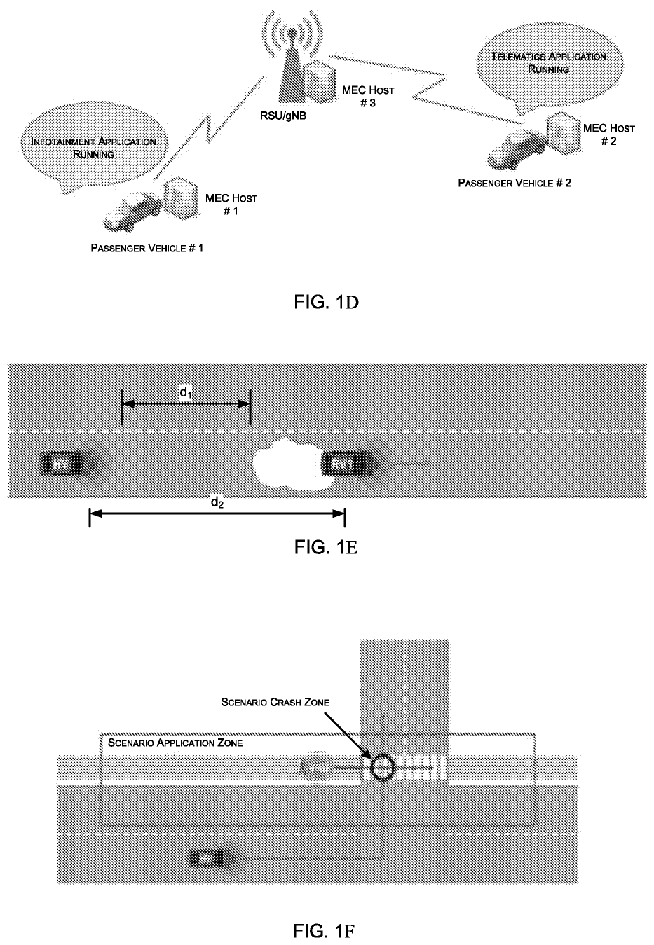

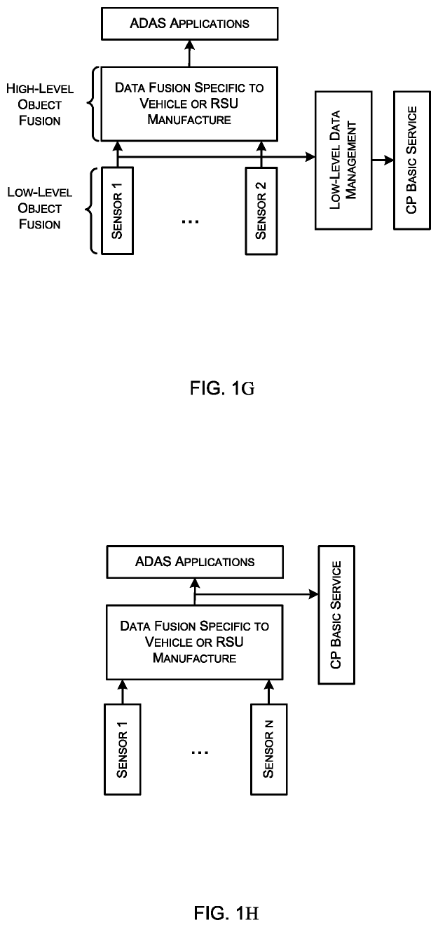

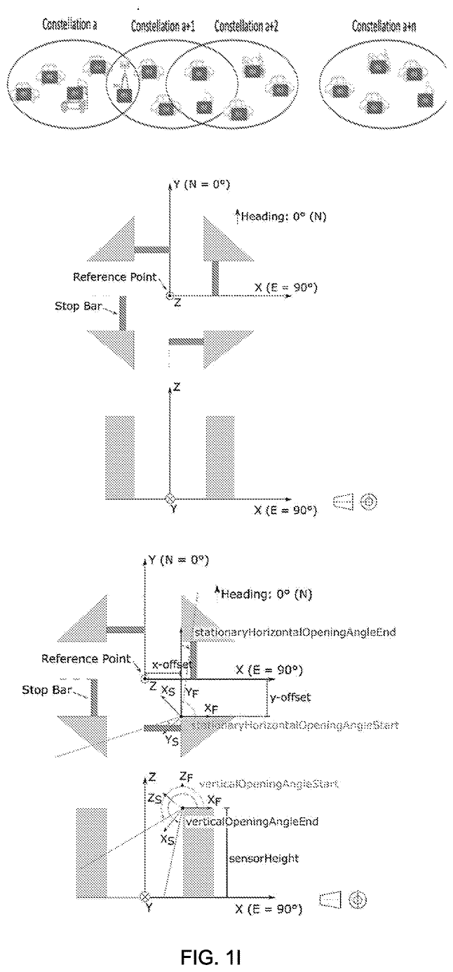

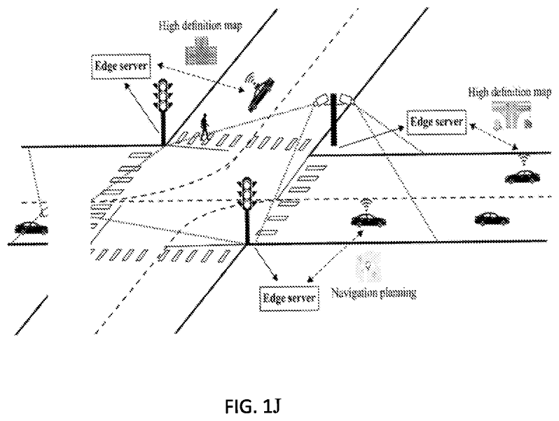

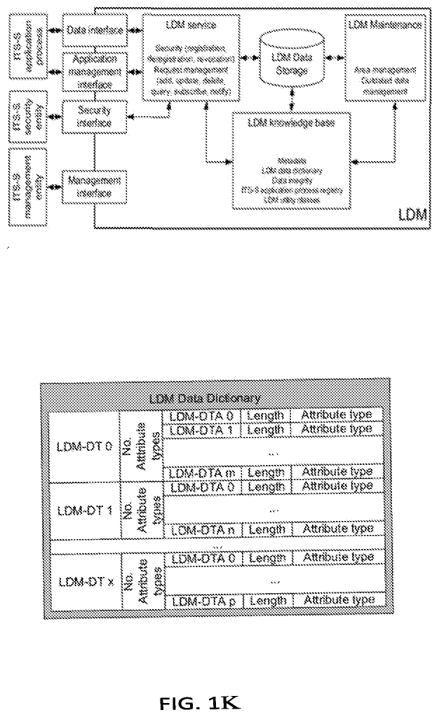

FIG. 1A illustrates an exemplary edge site connected using a network slice, in accordance with an embodiment of the present disclosure.

Referring to FIG. 1A, multi-access edge computing (MEC) system 100 configured for applications of connected and autonomous vehicles (CAVs). System 100 can include two components a hardware component (also referred to as device 102, herein) and a software component or a set of instruction 114 residing on device 102 shown in FIG. 1B. The device 102 shown in FIG. 1B can include a set of sensors 104, a set of network elements (106, 108), photovoltaic cell 110, massive MIMO antenna 112 (also referred to as reconfigurable radio systems 112, herein) and a processor 116. The set of network elements can be base station (gNB) remote radio unit (RRU) 106, V2X roadside units (RSU) antenna 108. The device 102 is spatially distributed at strategic locations on streets, highways, intersections, blind spots, high accident risk areas and the likes primarily to enable services contributing towards road safety and transmit information to control the movement of various objects in a safe and efficient manner. The objects can be selected from CAVs, humans, animals, and the like.

In sensor 104, emitted instantaneous optical frequency is periodically shifted, usually by varying power applied at the source. The reflected signal is mixed with the emitted source, creating a beat frequency that is a measure of the probed distance. The frequency difference between outgoing and incoming components is translated into a periodic phase difference between them that causes alternating constructive and destructive interference patterns to obtain a beat frequency and doppler effect. By using Frequency Fourier Transform (FFT) to transform beat signal in time domain to frequency domain, peak of the beat frequency can be translated into distance of objects. The lidar sensor working principles enable it to measure the surrounding environment using cartesian coordinate (x, y, z) in 3D space and its doppler measurements (v) for individual LiDAR points. The set of sensors 104 is adapted to capture the first set of attributes pertaining to information such as velocity, direction, and speed including Orientation Angle, Pitch Angle, Roll Angle, Height etc. of the objects to create a dynamic 4D point cloud map (roll, yaw, pitch, velocity) of the surrounding environment roads in real-time.

In an embodiment, RRU gNB 106 is wireless base station antenna operating on a virtual machine. RRU gNB 106 can include the transmitter and receiver, the processor coupled to the radio frequency (RF) transmitter and receiver to transmit and receive a set of signals to and from other devices e.g., other wireless base station antennas, also data centre, vehicles on road, smartphones, smart infrastructure.

The V2X RSU antenna 108 operators on a software stack running on the processor 116 of the device 102, the V2X RSU antenna 108 sends a set of data through an intelligent transport system (ITS) frequency, which is a special set of frequencies allocated all over the world, specifically for safety-related applications and intelligent transport system. The RRU gNB 106 and V2X RSU antenna 108 are adapted to capture the second set of attributes pertaining to location data and proximity data of the objects. The V2X RSU antenna 108 sends a set of data using Cooperative Awareness (CA) and Decentralized Environmental Notification (DEN) messages to communicate with vehicles in its coverage area.

Cooperative Awareness (CA): The device 102 runs V2X a CA basic service in a services based architecture. The road users and roadside infrastructure within road traffic means are informed about each other's position, dynamics, and attributes. The road users are all kinds of road vehicles like cars, trucks, motorcycles, bicycles or even pedestrians and roadside infrastructure equipment including road signs, traffic lights or buildings, barriers and gates. The situational awareness of each other's surrounding including connected object itself is the basis for several applications including road safety and traffic efficiency, in the proposed system. The information to be exchanged for cooperative awareness is packed up in the periodically transmitted cooperative awareness message (CAM) and Decentralised Environment Notification message (DENM). The construction, management and processing of CAMs and DENMs are done by the cooperative awareness basic service (CA basic service), which is part of the facilities layer within the ITS communication architecture supporting several ITS applications. The CA basic service is a mandatory facility for all kinds of ITS-Stations, which take part in the road traffic i.e., vehicle ITS-S, personal ITS-S and the likes.

Decentralized Environmental Notification (DEN): The DEN basic 10 service supports applications including a Road Hazard Warning (RHW) application which runs as a software service on device 102. The DEN basic service is an application support facility provided by the facilities layer. It constructs, manages, and processes the Decentralized Environmental Notification Message (DENM). The construction of a DENM is triggered by an ITS-S application. A DENM contains information including to a road hazard or an abnormal traffic condition, such as its type and its position. The DEN basic service delivers the DENM as payload to the ITS networking & transport layer for message dissemination. Typically for an ITS application, a DENM is disseminated to ITS-Ss that are in a geographic area through direct vehicle-to-vehicle or vehicle-to-infrastructure communications. On the receiving side, the DEN basic service of receiving ITS-S processes the received DENM and provides the DENM content to an ITS-S application. This ITS-S application may present the information to the driver/CAV if the information of the road hazard or traffic condition is assessed to be relevant to the driver/CAV. The driver/CAV is then able to take appropriate actions to react to the situation accordingly.

In an embodiment, the software component, or the set of instructions 114 installed on personal ITSs, Vehicle ITSs, roadside ITSs/MEC host hardware (RSU) and bare metal servers at the edge cloud, is a MEC host running a C-V2X application service and a private 5G network application service. The private 5G network application and C-V2X application service, among others, include a position and time services (PoTi), location-based service and a proximity-based Service (ProSe), collective perception service (CPS), vulnerable road user (VRU) awareness service, road hazard signalling (RHS) application, intersection collision risk warning (ICRW) application, and longitudinal collision risk warning (LCRW) application. The MEC host is geographically distributed with the last mile connected remote radio unit (RRU) running with zero-touch provisioning capability. The proposed system 100 adapted to localising the CAV in the real world and identifying the distance to other objects in the surrounding environment based on their proximity and exchanging the information with other LTE/5G-NR/C-V2X/Satellite connected objects to the system in its environment.

The processor 116 is operatively coupled to a learning engine to extract the first set of attributes in the form of depth and velocity information from the set of sensors 104, the first set of attributes pertaining to velocity, speed, direction, distance and position on road of the objects. The processor 116 is configured to receive the second set of attributes pertaining to location data and proximity data of the objects from the RRU gNB and V2X RSU transceivers using 5G/ITS protocols 108. The processor 116 is configured to fuse the first set of attributes and the second set of attributes to form a grid map (also referred to as local dynamic map (LDM), herein) and send it to any interested parties such as vehicles on the road. It can also include this local dynamic map while beam-sweeping and/or beamforming operations of LIDAR and/or 5GNR plus (C-V2X) transceivers.

In an embodiment, the device collects 4D point cloud data and forwards it to the MEC system 100 for processing and analytics. In another embodiment, the device 102 also forwards the data to the CAV connected to its coverage area directly over wireless communications including IP and/or Geo networking protocols. The CAV in the coverage area and/or sensor observed area of device 102 receives the data either via a cellular network over a network slice or via a C-V2X RSU PC5 Sidelink communication link (V2I/P2I) or a combination of both. The processor 116 is configured to receive the first set of attributes in the form of point cloud data. The point cloud data is used to store the collection of points. Point cloud also contains information such as timestamps from global positioning systems (GPS), colour, intensity, and the like. This data is then manipulated using deep learning on point cloud data for detection, segmentation, classification and tracking of all objects in the detection range of the device 102. The point cloud data is segmented to extract the objects and then classify the segmented objects. The classification can be performed by labelling the objects.

The point cloud data from multiple Lidar sensors 104 is concatenated with Global navigation satellite system (GNSS) data obtained from multiple sources on its hardware to create a real-time 3D data model of a particular geographic area with live on-road objects in the scene. The data is manipulated on a software application using an edge cloud platform. This particular geographic area is an Local Dynamic Map (LDM) edge site operating on a private 5G cellular network over a network slice and connected to multiple edge sites and the internet. V2X services run on an ad hoc network.

In an embodiment, the LDM is a microservice that runs on device 102 and is the most important part of the proposed system. It is a conceptual data store located within the ITS-S, containing information, which is relevant to the operation of ITS applications and related road safety and traffic efficiency. Information on a vehicle or roadside ITS-S for example is provided by a cooperative awareness basic service and is accessed from the LDM as an LDM Data Object with sub-objects representing the information from the CAM Basic Container or LDM data record. Information on an event for example is provided by a distributed environmental notification basic service and is accessed from the LDM as an LDM Data Object with sub-objects for the situation, location and a LDM data record.

The LDM can also store LDM Data Objects from applications and other facilities. For example, the LDM may maintain information on the ITS-S. The LDM does not modify the data provided by LDM Data Providers. No permanent, static information is required to be stored in the LDM.

The sharing of the LDM can be done through collective perception service (CPS), in the CPS, the CP message offers ITS stations the possibility to share information about objects in the surrounding, which have been detected by sensors, cameras or other information sources mounted to the transmitting traffic participant. Raw sensor data refers to low-level data generated by a local perception sensor that is mounted to an RSU. This data is specific to a sensor type (point 15 clouds). In the context of environment perception, this data is usually analysed and subjected to sensor-specific analysis processes to detect and compute a mathematical representation for a detected object from the raw sensor data.

The device 102 provides raw sensor data including point cloud. Because of its measurements which are used by a sensor-specific low-level object fusion system, i.e., the V2X-RSU MEC host application to provide a list of objects as detected by the measurement of the sensor. The detection mechanisms and data processing capabilities are specific to the hardware component. The definition and mathematical representation of an object can vary. This mathematical representation is called a state space representation and depending on the field of view of the Lidar sensor, it comprises multiple dimensions (e.g., relative distance components of the feature to the sensor, speed of the feature, geometric dimensions, etc.). A state space is generated for each detected object of a particular measurement. A measurement is performed cyclically, depending on the lidar sensor scanning frequency. After each measurement, the computed state space of each detected object is provided in an object list that is specific to the timestamp of the measurement. It is the task of an object fusion system to maintain a list of objects that are currently perceived by an ITS-S. Sensor scanning frequency may also be matched with Radio Frequency (RF) elements including transceivers enabling focused beamforming and beams weeping.

Referring to FIG. 1A, the two private 5G networks connected to the MEC system 100 i.e., edge cloud using a network slice. The term “network slicing” is a concept where logical networks/partitions are created, with appropriate isolation, resources, and optimized topology to serve the connectivity requirements of CAV, particularly of extended sensors and advanced driving use cases. The butterfly-shaped device 102 is installed on roadside infrastructure shown in FIG. 1B at a height of approximately 8-10 meters to capture the data more widely and to create a dynamic 4D point cloud map (latitude, longitude, altitude, velocity) of the surrounding environment roads in real-time using the LiDAR sensor 104.

As shown in FIG. 1A, multiple roadside MEC host hardware 102 is installed at intersections, blind spots, high accident risk areas and the likes primarily to enable services contributing towards road safety. To do this, system 100 needs to create a cyber-physical system of the surrounding real-world environment and communicate this information to stakeholders involved in road safety within the threshold service requirements of CAV. For this reason, system 100 uses a combination of lidar sensor, GNSS, V2X and 5G technologies.

The lidar 104 works on principles of reflection. One limitation of the system is occlusion. To overcome this, device 102 is installed in such a way that it creates a point cloud digital twin of the surrounding environment and every object in lidar's field of view is successfully detected, segmented, classified and then tracked a minimum of once and the system communicates this information to CAV and ITS-S connected to hardware's cellular and V2X coverage area. The system tracks objects in the scene using a combination of deep learning on point cloud 15 data and Location API and Proximity Services.

Further, to provide cellular coverage and V2X services, device 102 includes the processor 114, storage, V2X RSU antenna(s) 108 and massive-MIMO transceiver antennas 112. The C-V2X application and private 5G network application run as software microservice on roadside MEC host hardware.

The roadside MEC host hardware runs on P4 and OpenFlow, it is a unified flow-based device whereas the MEC edge cloud system is an SDN controller. While OpenFlow is designed for SDN networks in which the control plane and the forwarding plane are separate, P4 is designed to program the behaviour of any switch or router, whether it's controlled locally from a switch operating system, or remotely by an SDN controller. This is achieved by reconfigurable radio systems. To meet URLLC and eMBB requirements, Sparse Code Multiple Access (SCMA) which is a Non-Orthogonal Multiple Access technique is used on the Air interface along with OFDMA.

The device 102 is an integrated access and backhaul (IAB) radio node and forms two types of networks such as vehicular ad hoc networks (VANETs) and/or mesh networks connected wirelessly over a mmWave 5G communication link that meets service requirements for enhanced V2X scenarios like Extended sensors and Advanced driving using Cloud-radio access network (RAN).

The term “Application Programming Interface (APIs)” are used to communicate between application services. Radio Network Information API (RNIS) is a service that provides radio network-related information to mobile edge applications and mobile edge platforms Location API is a service to provide location-related information to the Mobile edge platform or authorized applications. User equipment (UE) Identity API is used to allow UE-specific traffic rules in the mobile edge system. Using bandwidth management API, a specific session or mobile edge application can be identified using a set of filters within the resource request. Few of the nodes in an edge site are connected to the MEC edge system via a local breakout point for that edge site and are connected to the core network by internet service providers (ISP), this coordination between inter-MEC systems and MEC-cloud systems is done to manage and orchestrate with Management and Orchestration (MANO) also leveraging a Zero-touch network and Service Management (ZSM). Internet protocol is used to connect all the edge sites to each other via the internet. Deployment architecture of IPv6-based Software-Defined Networking (SDN) and Network functions virtualization (NFV) including e.g., process flow-based service to ensure that the distributed MEC system works correctly, integration of Internet Protocol version 6 (IPv6)-based data centres, networks, and cloud.

Network slicing, segment routing over IPv6, and clock distribution are used to meet ultra-reliable low-latency communication (URLLC) service, 5GS support for URLLC communication. Also, to ensure that all the services on MEC edge systems are always available to UEs and ITS-S, enhanced domain name system (DNS) support towards distributed MEC environments. The roadside MEC host device and MEC system meet the energy efficiency of a 5G system.

FIG. 1C illustrates an exemplary hypothetical installation of a hardware component on a traffic signal column at an intersection, in accordance with an embodiment of the present disclosure. As depicted in FIG. 1C, device 102 is installed on existing roadside infrastructure e.g., streetlights, apartments, buildings, and the likes after calibration of Lidar sensor(s) and cellular equipment.

Device 102 collects 4D point cloud data and forwards it to the MEC system 100 for processing and analytics. The device 102 also forwards the data to the CAV connected to its coverage area directly over IP and/or Geo networking protocols. The CAV in the coverage area of device 102 receives the data either via a cellular network over a network slice or via a C-V2X RSU communication link or a combination of both.

The term “Geo-Networking” is a network-layer protocol for mobile ad hoc communication based on wireless technology, such as ITS-G5. It provides communication in mobile environments without the need for a coordinating infrastructure. Geo-Networking utilizes geographical positions for the dissemination of information and transport of data packets. It offers communication 20 over multiple wireless hops, where nodes in the network forward data packets on behalf of each other to extend the communication range.

In an embodiment, the MEC system 100 or edge cloud can be a geographically distributed data centre that meets CAV connectivity service requirements. The data centre can include three fundamental components such as Compute including central processing unit (CPU), network and storage. The data centre can compute multiple instances of core processes running simultaneously, isolated inside the CPU. This enables the virtualization of application workloads to run as Virtual Network Function (VNF) on an NFV infrastructure. The CPU can be connected to a type of network that is either wired or wireless or a combination of both. The network also depends on the model of virtualization, e.g., a balanced type of configuration or an asymmetrical type of configuration. Network slicing is used to assure service requirements of CAV applications. Storage is a solid-state drive that assures performance and reliability. Permissioned Distributed Ledger (PDL) technology is used for data storage along with other data storage technologies.

The CAV needs to localise itself in the real world and identify its location and inertial information in relation to other objects in its environment based on its proximity to those objects. This is enabled by 5GS location services and ProSe. The software component running on hardware enables location services for CAV to localise itself in the real-world using 5G-NR/C-V2X technologies including GPS information like World Geodetic System 1984 (WGS 10 84)-GPS coordinates and/or (Radio Technical Commission for Maritime Services) RTCM information and inertial information i.e., velocity, direction, speed of objects in its proximity using FMCW LiDAR.

FIG. 1D illustrates a cellular vehicle to everything (C-V2X) application, in accordance with an embodiment of the present disclosure. Referring to FIG. 1E, in an exemplary implementation, MEC host 3 in this example is the roadside MEC host hardware component or device 102 in the system. The key differences in the proposed solution and example is that C-V2X RSU and gNB-RRU are MEC software applications running on hardware which is a software reconfigurable radio equipment (RRE). The MEC host 3 creates a digital twin of the surrounding environment in 4D point cloud data and sends the data over Geo-Networking and/or IP protocol to CAVs and ITS-S directly connected to it in its coverage area using location API and proximity services. In this example case, MEC host 1 and MEC host 2, may or may not be running the same MEC application. This is performed through three types of communication services namely co-operative road safety, traffic efficiency and map download and update.

FIG. 1E shows an example of how roadside hardware builds a local dynamic map (LDM) using 4D point cloud data, location API and ProSe to provide information to CAV.

FIG. 1F It shows a Road hazard warning application implemented as a microservice on the proposed roadside MEC host hardware component 102.

FIG. 1G illustrates object data extraction levels to be considered as a part of CP basic service, in accordance with an embodiment of the present disclosure. These tasks of object fusion may be performed either by an individual sensor or by a high-level data fusion process. The CP service enables sharing of object information from both regimes. As depicted an implementation in which sensor data is processed as part of a low-level data management entity. The CP basic service then selects the object candidates to be transmitted to avoid filter cascades, as the task of high-level fusion will be performed by the receiving ITS-S. FIG. 1H depicts an implementation in which the CP basic service selects objects to be transmitted as part of the CPM from a high-level fused object list, thereby abstracting the original sensor measurement used in the fusion process. The CPM 15 provides data fields to indicate the source of the object.

FIG. 1I illustrates a schematic view of the road side unit, in accordance with an embodiment of the present disclosure. An ITS Station (ITS-S) is a key component of the ITS, and its effectiveness depends on the presence of other ITS-Ss within its communication range. Sometimes, a ITS-S may find itself in a situation where no other ITS-Ss are active within its communication range, resulting in limited or isolated data exchange. On the other hand, at different times, the same ITS-S might be in a situation where numerous other ITS-Ss are active within its communication range, allowing for extensive data sharing and collaboration.

To facilitate effective communication and data exchange, ITS Constellations (ITS-Cs) are formed. An ITS-C is a group of ITS-Ss that communicate with each other, creating a network for data sharing and coordination. These ITS-Cs may overlap, meaning that an ITS-S can be part of multiple ITS-Cs simultaneously. However, it is not necessary for an ITS-S to be active in all ITS-Cs, as different constellations may serve various purposes and cover different geographic areas or specific transportation scenarios.

Coordinate System to be used for RSU as disseminating ITS-S is shown in FIG. 1I. The corresponding information where a perception system is mounted to an RSU, the position provided by the offset from a reference point on the vehicle also serves as the origin of a sensor-specific local cartesian coordinate system. Being provided with the sensor position and the opening angles, the receivers of the information can determine the sensor measurement area by projecting the area defined by the opening angles on the ground FIG. 1I.

The flexibility of ITS-Cs allows for optimized communication and resource utilization within the transportation system. By enabling efficient data exchange between vehicles, infrastructure, and other stakeholders, ITS and V2X technologies pave the way for advancements in autonomous driving, traffic management, and road safety.

FIG. 1J illustrates a schematic view of local dynamic map, in accordance with an embodiment of the present disclosure. The local dynamic map (LDM) is an entity that can include LDM data objects, services and interfaces for manipulating these LDM data objects. A local dynamic map (LDM) is a comprehensive entity designed to store and manage real-time data related to the surrounding environment in a localized area. It comprises LDM data objects, which represent various elements such as road conditions, traffic incidents, weather information, and nearby vehicles. The LDM also encompasses services and interfaces that enable seamless manipulation and interaction with these data objects, allowing for the efficient exchange of information between vehicles, infrastructure, and other Intelligent Transport Systems (ITS) components. Through LDM, vehicles can access up-to-date and relevant information, contributing to improved situational awareness, enhanced navigation, and overall safer and more efficient driving experiences.

FIG. 1K illustrates a structure of the LDM, in accordance with an embodiment of the present disclosure.

A function F that an ITS station can use to determine whether a point P(x,y) is located inside, outside, at the centre, or at the border of a geographical area. The geographical area selected from circular area, rectangular area and ellipsoidal area.
F(x,y) {=1 for x=0 and y=0 (at the centre point)
>0 inside the geographical area
=0 at the border of the geographical area
<0 outside of the geographical area}
   Where x,y are the geographical coordinates of P

The circular area shall be described by a circular shape with a single point A that represents the center of the circle and a radius (r). In an implementation, for a circular area the function F is defined by equation given below:

$$F ( x , y ) = 1 - {( \frac{x}{r} )}^{2} - {( \frac{y}{r} )}^{2}$$

The rectangular area shall be defined by a rectangular shape with point A that represents the center of the rectangle and the following parameters: the distance between the center point and the short side of the rectangle (perpendicular bisector of the short side), b the distance between the center point and the long side of the rectangle (perpendicular bisector of the long side), θ azimuth angle of the short side of the rectangle. Subsequently, for a rectangular area the function F is defined by equation given below:

$$F ( x , y ) = Minimum ( 1 - {( \frac{x}{a} )}^{2} , 1 - {( \frac{y}{b} )}^{2} )$$

The ellipsoidal area shall be defined by an ellipsoidal shape with point A that represents the center of the rectangle and the following parameters: the length of the long semi-axis, b the length of the short semi-axis, θ azimuth angle of the long semi-axis. Further, for an ellipsoidal area the function F is defined by equation given below:

$$F ( x , y ) = 1 - {( \frac{x}{a} )}^{2} - {( \frac{y}{b} )}^{2}$$

By utilizing function F, the ITS station can effectively determine the spatial relationship between a point P and different geographical areas, aiding in various applications such as geofencing, collision avoidance, and location-based services within the intelligent transport system.

Thus, the present invention overcomes the drawbacks, shortcomings, and limitations associated with existing solutions, and provides a system that simultaneously reduces the number of sensors and processing power required per ego vehicle, and enables vehicles to securely share all the data among neighbouring vehicles using private 5G and V2X technologies to achieve collective perception and localises a CAV in the real world and identifying distance to other objects in surrounding environment based on their proximity to it and exchange information with other objects in its environment.

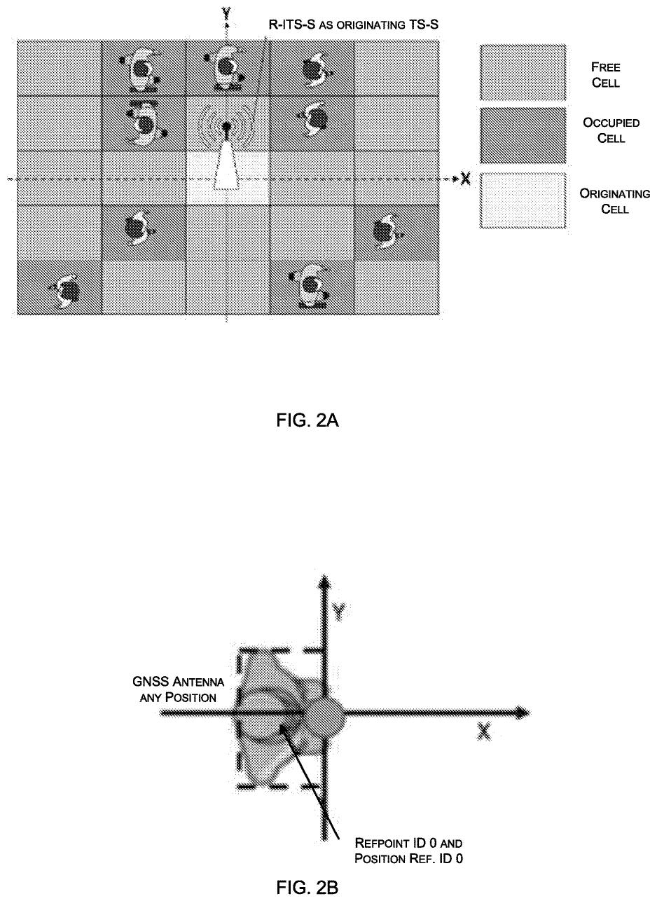

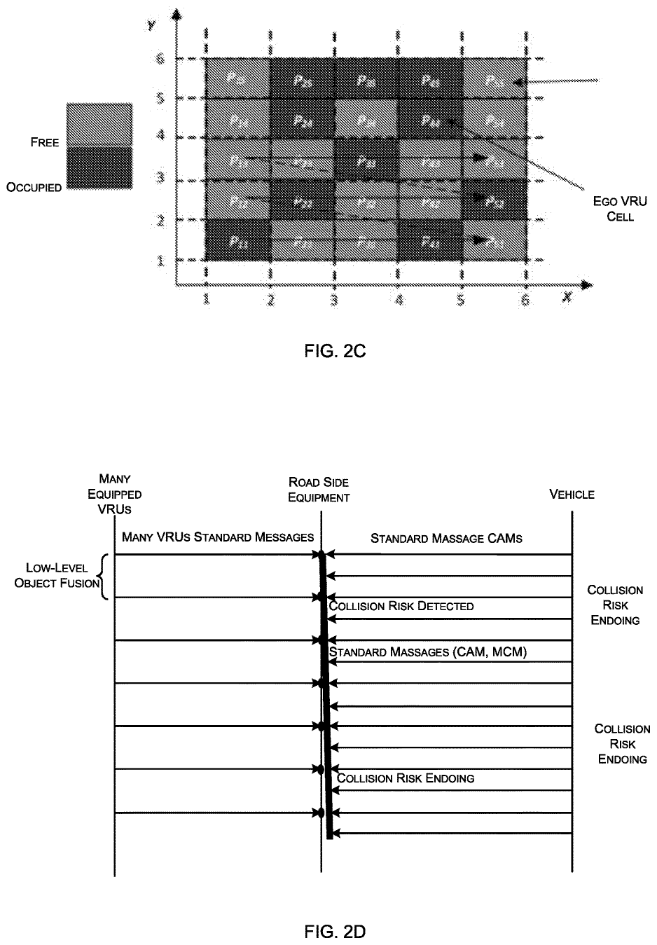

FIG. 2A illustrates an exemplary roadside hardware component 25 sensing its surrounding road environment, in accordance with an embodiment of the present disclosure. As depicted in FIG. 2A, device 102 installed on the roadside configured to sense its surrounding road environment using a combination of Lidar and V2X services.

FIG. 2B illustrates exemplary roadside hardware sensing a reference position of a vulnerable road user (VRU), in accordance with an embodiment of the present disclosure. As shown in FIG. 2B, the device 102 can sense a reference position of the VRU such as pedestrians, vehicles, motorcycles, and cyclists on road using GNSS and LiDAR. For pedestrians, referring to the ground position at the center-point of the face side of the pedestrian bounding box and location services. This is done by position and time services (PoTi).

FIG. 2C illustrates exemplary roadside hardware (R-ITS-S) that creates a proximity-based grid occupancy map of its surrounding road environment, in accordance with an embodiment of the present disclosure. Referring to FIG. 2C, device 102 creates a proximity-based grid occupancy map of its surrounding road environment with a bitmap of the occupancy values.

FIG. 2D illustrates an exemplary framework of the roadside hardware component, in accordance with an embodiment of the present disclosure. As depicted in FIG. 2D, the device 102 installed on the roadside detects one or more VRUs in a protected area i.e., the on-road detection range of the device 102 and sends or relays the information to its surrounding connected vehicles.

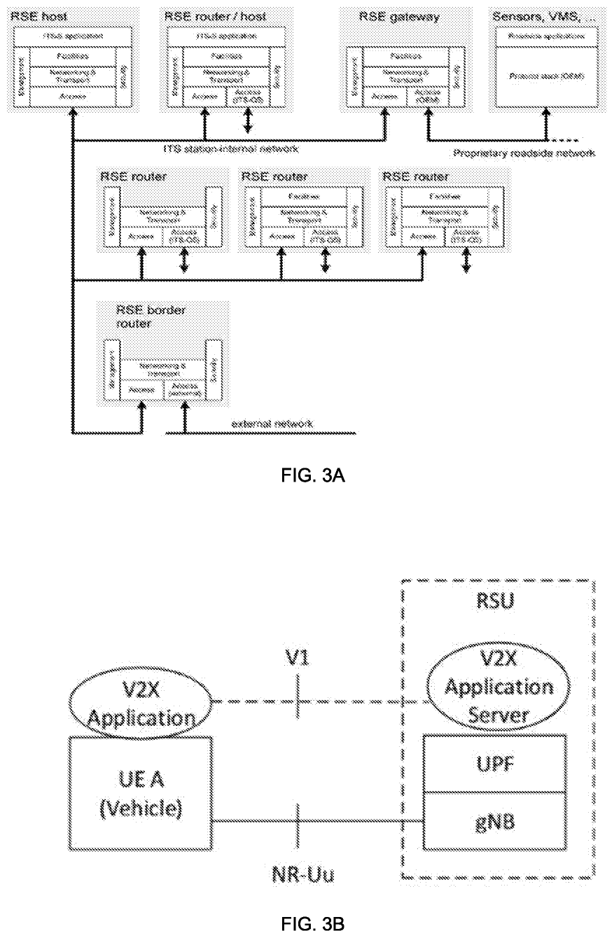

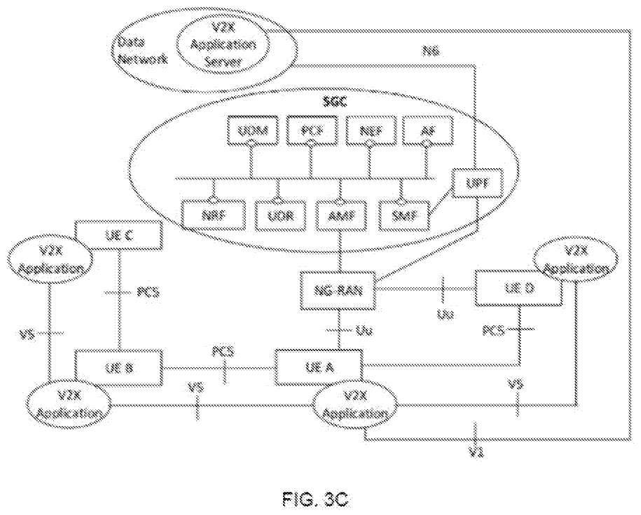

FIG. 3A illustrates an exemplary implementation of roadside V2X service, in accordance with an embodiment of the present disclosure.

FIG. 3B illustrates an exemplary logical implementation of a roadside unit in 5GS, in accordance with an embodiment of the present disclosure. The logical implementation of the roadside unit in 5GS includes a gNB, collocated UPF and a V2X application server.

FIG. 3C illustrates an exemplary high-level view of the non-roaming 5G system architecture for V2X communication, in accordance with an embodiment of the present disclosure. The high-level view of the non-roaming 5G system architecture for V2X communication over PC5 Sidelink and Uu reference points capturing logic V2X in 5GS roaming architecture.

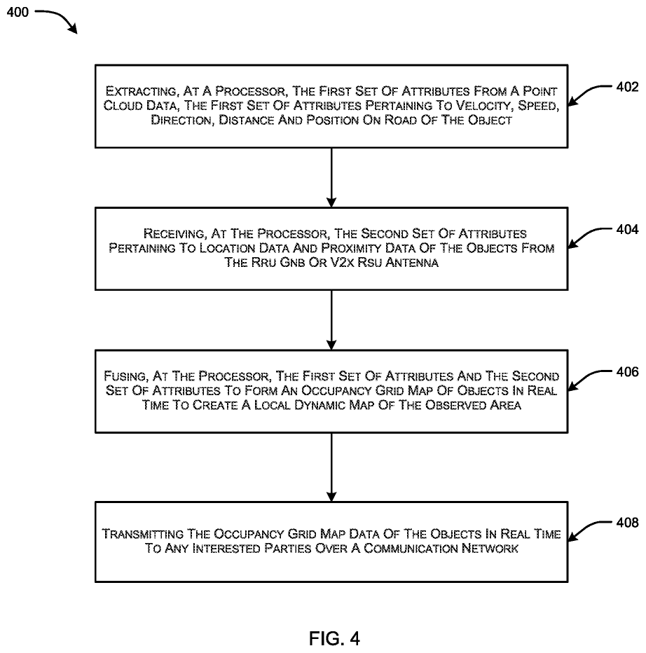

FIG. 4 illustrates a flow chart of a method for determining the surrounding environment for CAVs, in accordance with an embodiment of the present disclosure.

Referring to FIG. 4, method 400 includes block 402, the processor 116 is operatively coupled to a learning engine to extract the first set of attributes in the form of of depth and velocity information from the set of sensors, the first set of attributes pertaining to velocity, speed, direction, position and distance on the roads of the objects. At block 404, the processor is configured to receive the second set of attributes pertaining to location data and proximity data of the objects from the set of network elements such as RRU gNB 106 or V2X RSU antenna 108. At block 406, processor 116 is configured to fuse the first set of attributes and the second set of attributes to form an occupancy grid map of objects in real time to create a local dynamic map of the observed area and at block 408 send the grid map data to any interested parties such as pedestrians, 10 vehicles on the road over a communication network.

CAV examples use case services including as follows:

Advanced driving enables semi-automated or fully automated driving. A longer inter-vehicle distance is assumed. Each vehicle and/or RSU shares data obtained from its local sensors with vehicles in proximity, thus allowing vehicles to coordinate their trajectories or manoeuvres. In addition, each vehicle shares its driving intention with vehicles in proximity. The benefits of this use case group are safer travelling, collision avoidance, and improved traffic efficiency.

Remote driving enables a remote driver or a V2X application to 25 operate a remote vehicle for those passengers who cannot drive themselves or a remote vehicle located in dangerous environments. For a case where variation is limited and routes are predictable, such as public transportation, driving based on cloud computing can be used. In addition, access to a cloud-based backend service platform can be considered for this use case group.

Vehicles Platooning enables the vehicles to dynamically form a group travelling together. All the vehicles in the platoon receive periodic data from the leading vehicle, to carry on platoon operations. This information allows the distance between vehicles to become extremely small, i.e., the gap distance translated to time can be very low (sub-second). Platooning applications may allow the vehicles following to be autonomously driven.

It will be apparent to those skilled in the art that the system 100 of the disclosure may be provided using some or all of the mentioned features and components without departing from the scope of the present disclosure. While various embodiments of the present disclosure have been illustrated and described herein, it will be clear that the disclosure is not limited to these embodiments only. Numerous modifications, changes, variations, substitutions, and equivalents will be apparent to those skilled in the art, without departing from the spirit and scope of the disclosure, as described in the claims.

### Advantages of the Present Invention

The present invention provides a system that makes CAVs more aware of their surrounding environments, resulting in the driving safety of the user.

The present invention provides a system that simultaneously reduces the number of sensors and processing power required per ego vehicle.

The present invention provides a system that enables vehicles to securely share all the data among neighbouring vehicles using private 5G and V2X technologies to achieve collective perception.

The present invention provides a system that localises a CAV in the real world and identifies distance to other objects in the surrounding environment based on their proximity to it and exchanges information with other objects in its environments. This information is stored distributedly on Permissioned distributed ledger technologies.

I claim:

1. A system (100) for connected and autonomous vehicles (CAV), the system comprising:
a device (102) equipped with a set of sensors (104) to capture a first set of attributes;
a set of network elements configured in the device to capture a second set of attributes; and
a processor (116) operatively coupled to the device; the processor configured to:
extract, from the set of sensors, the first set of attributes, the first set of attributes pertain to velocity, speed, direction, distance, and position of the objects;
extract, from the set of network elements, the second set of attributes, the second set of attributes pertains to location data and proximity data of the objects;
fuse the first set of attributes and the second set of attributes to form an occupancy grid map of objects in real time to create a local dynamic map (LDM) of the observed area; and
share the occupancy grid map data of the objects in real time to any interested parties over a communication network.

2. The system as claimed in claim 1, wherein the device (102) is spatially distributed at strategic locations such as on streets, highways, intersections, blind spots, high accident risk areas and any combination thereof, wherein the device enable services contributing towards road safety and traffic efficiency information and to control the movement of various objects in a safe and efficient manner.

3. The system as claimed in claim 1, wherein the set of sensors (104) is Frequency Modulated Continuous Wave (FMCW) light detection and ranging (LiDAR) and the set of network elements is remote radio unit (RRU) (gNB) wireless base station (106) and vehicle-to-everything (V2X) roadside units (RSU) (108).

4. The system as claimed in claim 1, wherein the device (102) comprises reconfigurable radio systems (112) that exploit the capabilities of reconfigurable radio and networks for self-adaptation to a dynamically-changing environment having learning capabilities, wherein the reconfigurable radio acquires knowledge of the radio operational environment and autonomously adjust its operational parameters and protocols accordingly, thereby facilitating the collection of cognitive radio context information for informed decision making.

5. The system as claimed in claim 1, wherein the processor (116) is operatively coupled to a learning engine to extract the first set of attributes and the second set of attributes to form the occupancy grid map by object fusion mechanism, wherein the learning engine is deep learning engine.

6. The system as claimed in claim 5, wherein the object fusion mechanism enables predictive tracking, association, and merging of object data from various set of sensors and V2X information, providing an updated object list for informed decision-making in Intelligent Transportation Systems (ITS), wherein the object fusion mechanism performs housekeeping tasks, including adding, updating, and removing state spaces for tracked objects based on sensor data, and supports object classification capabilities based on the fusion capabilities.

7. The system as claimed in claim 1, wherein the local dynamic map (LDM) employs a distributed ledger architecture, facilitating secure access to its data through permission-based processes and modular possibilities, wherein the LDM stores information in the form of LDM data objects, which can be composed of sub-objects, resembling the hierarchical structure of data frames in messages, the LDM data objects are equipped with attributes that represent various data elements, wherein the data is received from a range of different sources such as internet, connected vehicles, infrastructure units, traffic control unit, personal ITS stations, and onboard sensors and applications.

8. The system as claimed in claim 1, wherein the local dynamic map determine whether a point P(x, y) is located inside, outside, at the center, or at the border of a geographical area, which comprise circular area, rectangular area, ellipsoidal area and any combination thereof.

9. The system as claimed in claim 1, wherein the device (102) is configured as an extended sensors system that facilitates the exchange of raw or processed data obtained from local sensors or live video data among vehicles, roadside units, user equipment (UEs) of pedestrians, and Vehicle-to-Everything (V2X) application servers, wherein through this exchange, vehicles gain the capability to enhance their environmental perception beyond the limitations of their own sensors, thereby achieving a more comprehensive and holistic view of the local situation.

10. A method (400) for connected and autonomous vehicles, the method comprising:
extracting (402), at a processor, a first set of attributes, the first set of attributes pertain to velocity, speed, direction, distance, and position on the road of the objects, wherein the device equipped with a set of sensors (104) to capture the first set of attributes;
extracting (404), at the processor, from a set of network elements, the second set of attributes, the second set of attributes pertains to location data and proximity data of the objects, the set of network elements configured in the device to capture the second set of attributes;
fusing (406), at the processor, the first set of attributes and the second set of attributes to form an occupancy grid map of objects in real time to create a local dynamic map (LDM) of the observed area; and
sharing (408) the occupancy grid map data of the objects in real time to any interested parties over a communication network.
